(19) United States
(12) Patent Application Publication
(10) Pub. No.: US 2025/0238082 A1
(43) Pub. Date: Jul. 24, 2025

(54) PSEUDO HAPTIC SENSE PRESENTATION APPARATUS, PSEUDO HAPTIC SENSE PRESENTATION METHOD, AND PROGRAM

(71) Applicant: NIPPON TELEGRAPH AND TELEPHONE CORPORATION, Tokyo (JP)

(72) Inventors: Takahiro KAWABE, Tokyo (JP); Takumi YOKOSAKA, Tokyo (JP); Yusuke UJITOKO, Tokyo (JP)

(73) Assignee: NIPPON TELEGRAPH AND TELEPHONE CORPORATION, Tokyo (JP)

(21) Appl. No.: 18/704,404

(22) PCT Filed: Nov. 4, 2021
(86) PCT No.: PCT/JP2021/040589

§ 371 Date: Apr. 24, 2024

(51) Int. Cl. G06F 3/01; G06F 3/04845; G06F 3/0488

(52) U.S. Cl. CPC G06F 3/016; G06F 3/04845; G06F 3/0488

(57) ABSTRACT

A visual object is visually changed by a magnitude of visual change of the visual object according to a manipulation based on a motion of a body part on the basis of manipulation information indicating the manipulation and information indicating a relationship between the magnitude of visual change and a manipulation amount based on the manipulation, and information for presenting the visually changed visual object is output. Here, this relationship is defined at least according to an index representing a degree of a pseudo haptic sense to be presented.

### TECHNICAL FIELD

The present invention relates to a technique for presenting a pseudo haptic sense.

### BACKGROUND ART

By manipulating visual information on the basis of information obtained from a haptic input device such as a mouse, a keyboard, a touch pen, or a reaction force presentation device, visual feedback to the haptic input can be given to a user. At this time, a haptic impression different from an actual haptic impression can be given to the user in an illusion manner by giving delays or fluctuations to the visual feedback. This technique is referred to herein as a pseudo-haptic technique.

There is also a technique for giving a haptic impression to a user by manipulating visual information on the basis of tracking information while tracking a user's body motion or hand motion in a touchless manner, instead of a haptic input device. For example, Non Patent Literature 1 discloses a touchless pseudo-haptic technique in a carousel interface that slides a video to the left and right on the basis of a swipe gesture of a user. In this technique, a friction coefficient and a magnetic force are applied to the movement of the carousel on the basis of physical operation, thereby giving a pseudo haptic sense to the user while reproducing natural movement and stop of the carousel. Non Patent Literature 2 discloses that, in a virtual reality environment, by manipulating a speed difference between a real object gripped in a real space and visual feedback, it is felt that the heaviness of the real object changes.

### CITATION LIST

### Non Patent Literature

Non Patent Literature 1: Gaucher, P., Argelaguet, F., Royan, J. & Lecuyer, A., “A novel 3D Carousel based on Pseudo-Haptic Feedback and Gestural Interaction for Virtual Showcasing”, [online], 2013, 2013 IEEE Symposium on 3D User Interfaces (3DUI), 55-58, [retrieved on Oct. 21, 2021], Internet <https://doi.org/10.1109/3dui.2013.6550197>
Non Patent Literature 2: Samad, M., Gatti, E., Hermes, A., Benko, H. & Parise, C., “Pseudo-Haptic Weight: Changing the Perceived Weight of Virtual Objects By Manipulating Control-Display Ratio”, 2019, Proceedings of the 2019 CHI Conference on Human Factors in Computing Systems, 1-13, Internet <https://doi.org/10.1145/3290605.3300550>

### SUMMARY OF INVENTION

### Technical Problem

There is no known technique for allowing a user to perceive a pseudo haptic sense without performing a complicated physical operation for simulating a real environment or using a haptic sense based on a physical reaction to a motion of a human body. For example, in Non Patent Literature 2, although the heaviness of the object in the virtual environment is modulated by a pseudo haptic sense, the speed difference between the haptic sense due to the physical reaction received from the gripped real object and the visual feedback is used, and the user is not allowed to perceive the pseudo haptic sense without using the haptic sense due to the physical reaction to the motion of the human body.

The present invention has been made in view of these points, and an object of the present invention is to allow a user to perceive a pseudo haptic sense without performing a complicated physical operation for simulating a real environment or using a haptic sense based on a physical reaction to a motion of a human body.

### Solution to Problem

A visual object is visually changed by a magnitude of visual change of the visual object according to a manipulation based on a motion of a body part on the basis of manipulation information indicating the manipulation and information indicating a relationship between the magnitude of visual change and a manipulation amount based on the manipulation, and information for presenting the visually changed visual object is output. However, this relationship is defined at least according to a degree of a pseudo haptic sense to be presented.

### Advantageous Effects of Invention

Accordingly, it is possible to allow the user to perceive a pseudo haptic sense without performing a complicated physical operation for simulating the real environment or using a haptic sense based on a physical reaction to the motion of the human body.

### BRIEF DESCRIPTION OF DRAWINGS

FIG. 1 is a block diagram illustrating a pseudo haptic sense presentation system according to an embodiment.

FIG. 2 is a conceptual diagram illustrating the pseudo haptic sense presentation system according to the embodiment.

FIG. 3 is a graph illustrating a relationship between a magnitude of visual change of a visual object and a manipulation amount in a first embodiment.

FIGS. 4A to 4C are diagrams illustrating a relationship between a magnitude of visual change of a visual object and a manipulation amount in the first embodiment.

FIGS. 5A to 5C are diagrams illustrating a relationship between a magnitude of visual change of a visual object and a manipulation amount in the first embodiment.

FIG. 6A is a diagram for describing experimental contents showing effects of the first embodiment. FIG. 6B is a graph illustrating a relationship between a magnitude of diameter change or phase change (phase shift) of a visual object (magnitude of visual change of the visual object) and a vertical height of a hand (manipulation amount based on manipulation).

FIG. 7 is a graph illustrating experimental results showing effects of the first embodiment. FIG. 7 illustrates a relationship between a ratio (speed ratio) of a magnitude of diameter change of a visual object (magnitude of visual change of the visual object) for visual stimulation to a magnitude of diameter change of a visual object (magnitude of visual change of the visual object) for reference and a degree (rating score) of a heaviness sense (pseudo haptic sense) perceived by a subject.

FIG. 8 is a diagram illustrating a visual object according to a second embodiment.

FIGS. 9A to 9C are diagrams illustrating a relationship between a magnitude of visual change of a visual object and a manipulation amount in the second embodiment.

FIGS. 10A to 10C are diagrams illustrating a relationship between a magnitude of visual change of a visual object and a manipulation amount in the second embodiment.

FIGS. 11A to 11C are diagrams illustrating a relationship between a magnitude of visual change of a visual object and a manipulation amount in a modification example of the second embodiment.

FIG. 12A is a diagram for describing experimental contents showing effects of the second embodiment. FIG. 12B is a graph illustrating experimental results showing effects of the second embodiment. FIG. 12B illustrates a relationship between a ratio (speed ratio) of a magnitude of phase change of a visual object (magnitude of visual change of the visual object) for visual stimulation to a magnitude of phase change of a visual object (magnitude of visual change of the visual object) for reference and a degree (rating score) of a heaviness sense (pseudo haptic sense) perceived by a subject.

FIG. 13 is a graph illustrating experimental results showing effects of the modification example of the second embodiment. FIG. 13 illustrates a relationship between a ratio (speed ratio) of a magnitude of phase change of a visual object (magnitude of visual change of the visual object) for visual stimulation to a magnitude of phase change of a visual object (magnitude of visual change of the visual object) for reference and a degree (rating score) of a heaviness sense (pseudo haptic sense) perceived by a subject.

FIG. 14 is a diagram illustrating a visual object according to a third embodiment.

FIG. 15A is a diagram for describing experimental contents showing effects of the third embodiment. FIG. 15B is a graph illustrating experimental results showing effects of the third embodiment. FIG. 15B illustrates a relationship between a ratio (speed ratio) of a magnitude of phase change of a visual object (magnitude of visual change of the visual object) for visual stimulation to a magnitude of phase change of a visual object (magnitude of visual change of the visual object) for reference and a degree (rating score) of a heaviness sense (pseudo haptic sense) perceived by a subject.

FIG. 16 is a block diagram illustrating a hardware configuration of a pseudo haptic sense presentation apparatus.

### DESCRIPTION OF EMBODIMENTS

Embodiments of the present invention will be described below with reference to the drawings.

### [Principle]

First, the principle of each embodiment will be described.

In each embodiment, a visual object is visually changed by a magnitude of visual change of the visual object according to a manipulation based on a motion of a body part on the basis of manipulation information indicating the manipulation and information indicating a relationship between the magnitude of visual change and a manipulation amount based on the manipulation, and the visually changed visual object is presented to a user. Here, the relationship between the magnitude of visual change of the visual object and the manipulation amount based on the manipulation is defined at least according to a degree of a pseudo haptic sense to be presented. Accordingly, it is possible to allow the user to perceive a pseudo haptic sense without performing a complicated physical operation for simulating the real environment or using a haptic sense based on a physical reaction to the motion of the human body. The pseudo haptic sense that can be presented is, for example, a heaviness sense. The heaviness sense can also be rephrased as a weight sense, a resistance sense, or the like.

Specific examples of the body part include a hand, a palm, an arm, a head, a face part, a waist, a trunk, and a foot, but this does not limit the present invention, and may be a manipulation based on a motion of any body part. The motion of the body part is, for example, a motion of the body part in a touchless environment. A touchless environment is an environment in which a physical reaction to the motion of the human body (that is, a reaction force due to the reaction) is not used for presentation of a pseudo haptic sense. An environment in which a human body does not grip or wear a physical input device is a touchless environment. Even if the human body grips or wears a physical input device (for example, a VR controller), if a physical reaction from the input device to the motion of the human body is not used for presentation of a pseudo haptic sense, the environment is a touchless environment. The motion of the body part may be a motion of moving the position of the body part, a motion of rotating the body part, a motion of deforming the body part, or a combination thereof. The position of the body part may be an absolute position or a relative position. An example of the former is a position of a coordinate system fixed to an external reference position (for example, the ground or the floor), and an example of the latter is a relative position with respect to a visual object or a device that presents the visual object. The position of the body part may be a position represented by a three-dimensional coordinate system, a position represented by a two-dimensional coordinate system, or a position represented by a one-dimensional coordinate system. The motion of rotating the body part may be a motion of absolutely rotating the body part or a motion of relatively rotating the body part. An example of the former is a motion of rotating a body part with respect to a coordinate system fixed to an external reference position, and an example of the latter is a motion of rotating a body part with respect to a visual object or a device that presents the visual object. The motion of deforming the body part is a motion of deforming the body part in accordance with the movement of muscles and joints. Examples of the motion of deforming the body part include a pinching motion with a finger and a motion of clenching a fist. The motion of the body part can be represented, for example, by the position, orientation, movement amount, rotation amount, movement speed, rotation speed, acceleration, angular acceleration, or a combination of at least some of these of the body part.

The manipulation based on the motion of the body part may be any manipulation as long as the manipulation is performed on the basis of the motion of the body part. For example, the manipulation based on the motion of the body part may be any manipulation as long as the manipulation content or the manipulation amount based on the manipulation is determined on the basis of the position, orientation, movement amount, rotation amount, movement speed, rotation speed, acceleration, angular acceleration, or a combination of at least some of these of the body part. For example, the manipulation by the body part performed in the touchless environment may be detected by a detection device such as a hand tracker, and the manipulation content or the manipulation amount based on the manipulation may be determined on the basis of the detected position, orientation, movement amount, rotation amount, movement speed, rotation speed, acceleration, angular acceleration, or a combination of at least some of these of the body part. The manipulation information indicating the manipulation based on the motion of the body part may be any information as long as the manipulation information indicates the manipulation based on the motion of the body part. For example, the manipulation information may be information indicating the manipulation content, information indicating the manipulation amount based on the manipulation, or information indicating both the manipulation content and the manipulation amount based on the manipulation. The manipulation content indicates the type of manipulation. Specific examples of the manipulation content include selection, start, continuation, and end of the manipulation. The manipulation amount based on the manipulation represents the amount of any type of manipulation. For example, the greater the motion of the body part, the greater the manipulation amount based on the manipulation. More specifically, for example, the greater the movement amount of the body part, the greater the manipulation amount based on the manipulation. Hereinafter, the manipulation amount based on the manipulation is referred to as a manipulation amount m. The manipulation amount m is, for example, an amount directly proportional to the movement amount of the body part. The movement amount of the body part may be used as the manipulation amount m as it is, or a function value (for example, a non-decreasing function value or a monotonically increasing function value) of the movement amount of the body part may be used as the manipulation amount m. The movement amount of the body part in this case may be a distance from a motion start position of the body part to a current position, may be a specific direction component (for example, a vertical component, a vertical upward component, a vertical downward component, a horizontal component, a horizontal specific direction component, and the like) of the distance from the motion start position of the body part to the current position, or may be a path from the motion start position of the body part to the current position. The motion start position of the body part may be, for example, a position of the body part at the time of transition from a state where a predetermined start condition is not satisfied to a state where the predetermined start condition is satisfied, or may be a predetermined position. Examples of the start condition include that the body part has started a motion or movement (Condition 1), that the body part has performed a specific trigger motion (for example, a pinching motion with a finger, a motion of clenching a fist, and the like) (Condition 2), that a positional relationship between the body part and the visual object or another position satisfies a predetermined condition (Condition 3), that a device state satisfies a predetermined condition (Condition 4), that a manipulation state of the device satisfies a predetermined condition (Condition 5), that there has been an output from another processing unit (Condition 6), and the like. Any combination of Conditions 1 to 6 may be used as the start condition. Note that the manipulation amount m may be a value of 0 or more, a positive value, a value of 0 or less, a negative value, or a value that can be positive, negative, or 0.

The visual object may be any object as long as it is visually perceived and visually changed by a magnitude of change according to the manipulation. For example, the visual object may be a two-dimensional image, a three-dimensional image, an image in a virtual space, a stereoscopic hologram, or an entity (for example, a mechanically moving attraction device, an advertisement signboard, or the like) in a real space. The visual change of the visual object is not limited, and for example, a size of the visual object may change, a shape of the visual object may change, a luminance may change, a color may change, the pattern may change, or any combination thereof may change. At least one of the luminance, the color, or the pattern of the visual object may change without changing the size or shape of the visual object. At least one of the luminance, the color, or the pattern of the visual object may or may not be uniform in a spatial region. At least one of the luminance, the color, or the pattern of the visual object may be periodic or aperiodic in the spatial region.

The magnitude of visual change of the visual object is a magnitude of change from the initial state to the current state of the visual element of the visual object. The initial state of the visual element of the visual object may be determined in advance, may be determined on the basis of input information, or may be determined on the basis of other information (for example, the position of the presented visual object). The initial state of the visual element of the visual object may be the same regardless of the degree of the pseudo haptic sense to be presented, or may be different depending on the degree of the pseudo haptic sense to be presented. However, in order to clarify the difference in the degree of the pseudo haptic sense to be presented, it is desirable to make the initial state of the visual element of the visual object the same regardless of the degree of the pseudo haptic sense to be presented. Hereinafter, the magnitude of visual change of the visual object is referred to as a magnitude of change c. The magnitude of change c corresponds to the magnitude of change of at least one of the size, the shape, the luminance, the color, or the pattern of the visual object, and at least one of the size, the shape, the luminance, the color, or the pattern of the visual object changes by the magnitude of change according to the manipulation based on the motion of the body part. Examples of the magnitude of size change of the visual object include a magnitude of diameter change, a magnitude of radius change, a magnitude of area change, and a magnitude of volume change of the visual object. Examples of the magnitude of shape change of the visual object include a magnitude of change in aspect ratio, a magnitude of change in aspect/depth ratio, and a magnitude of change in oblateness of the visual object. Examples of the magnitude of luminance change include a magnitude of luminance change, a magnitude of brightness change, and a magnitude of phase change in spatial region. Examples of the magnitude of color change include a magnitude of change in pixel value, a magnitude of change in color space, and a magnitude of phase change in spatial region. The magnitude of pattern change is a magnitude of phase change in spatial region, a magnitude of change in pixel value, a magnitude of change in pixel value, a sum of magnitudes of change in pixel value, and the like. The magnitude of change c may be a value of 0 or more, a positive value, a value of 0 or less, a negative value, or a value that can be positive, negative, or 0.

The relationship between the magnitude of visual change c of the visual object and the manipulation amount m based on the manipulation is defined according to a degree of a pseudo haptic sense to be presented. This relationship is defined according to the degree of the pseudo haptic sense to be presented. Hereinafter, this relationship is referred to as a relationship r. Only a single relationship r with respect to a degree of a single pseudo haptic sense may be defined, or a plurality of relationships r with respect to degrees of a plurality of pseudo haptic senses may be defined. Note that the degree of the pseudo haptic sense to be presented may be determined in advance, may be determined on the basis of the input information, or may be determined on the basis of other processing. Hereinafter, an index representing the degree of the pseudo haptic sense to be presented is referred to as an index i. An example of the index i is a value (for example, an index, a numerical value, a vector, or a symbol) representing the magnitude (strength) of the pseudo haptic sense, and is, for example, a value representing the magnitude of the heaviness sense, the magnitude of the weight sense, and the magnitude of the resistance sense. In a case where a plurality of relationships r with respect to degrees of a plurality of pseudo haptic senses are defined, the relationships r are also different if the pseudo haptic senses to be presented are different. That is, when the relationship in a case where the index i is i₁ (first index value) is referred to as a relationship r(i₁), and the relationship in a case where the index i representing the degree of the pseudo haptic sense to be presented is i₂ (second index value) different from i₁ is referred to as a relationship r(i₂), the relationship r(i₁) and the relationship r(i₂) are different. The relationship r between the magnitude of change c and the manipulation amount m may be a linear relationship or a non-linear relationship. An example of the relationship r is a ratio Δc/Δm of a change Δc in the magnitude of visual change c of the visual object to a change Δm in the manipulation amount m. For example, Δm means a unit manipulation amount in the manipulation amount m. For example, in a case where c is a function value f(m) of m, an example of the ratio r=Δc/Δm is the first derivative (slope) dc/dm for m of c=f(m). Here, f(·) means a function having · as a domain.

When the ratio r=Δc/Δm in a case where the index i is i₁ (first index value) is referred to as a ratio r(i₁) (first value), and the ratio r in a case where the index i is i₂ (second index value) different from i₁ is referred to as a ratio r(i₂) (second value), the ratio r(i₁) (first value) and the ratio r(i₂) (second value) are different from each other. For example, in a case where the degree of the pseudo haptic sense represented by the index i₁ (first index value) (for example, the magnitude of the pseudo haptic sense such as the magnitude of the heaviness sense, the magnitude of the weight sense, the magnitude of the resistance sense, and the like) is greater than the degree of the pseudo haptic sense represented by the index i₂ (second index value), the ratio r(i₁) (first value) is smaller than the ratio r(i₂) (second value). For example, the ratio r decreases as the degree of the pseudo haptic sense to be presented increases. In other words, the smaller the ratio r, the greater the degree of the pseudo haptic sense to be presented.

For the same index i, the ratio r=Δc/Δm may be constant regardless of the magnitude of m (at least within a predetermined m range), or the ratio r=Δc/Δm may be different according to the magnitude of m. That is, in a case where the manipulation amount m changes from m₁ (first manipulation amount) to m₂ (second manipulation amount) and/or the manipulation amount m changes from m₂ (second manipulation amount) to m₁ (first manipulation amount) according to the manipulation (m₁ is different from m₂), a ratio r (third value) when the manipulation amount m is the manipulation amount m₁ (first manipulation amount) and a ratio r (fourth value) when the manipulation amount m is the manipulation amount m₂ (second manipulation amount) may be equal to or different from each other. For example, in a case where the ratio r when the manipulation amount m is m₁ is r(i₁, m₁) (third value) and the ratio r when the manipulation amount m is the manipulation amount m₂ is r(i₁, m₂) (fourth value) with respect to the index i₁, r(i₁, m₁)=r(i₁, m₂), or r(i₁, m₁)≠r(i₁, m₂) (that is, r(i₁, m₂) (fourth value) is different from r(i₁, m₁) (third value)) may be satisfied. For example, the manipulation amount m₁ (first manipulation amount) may be greater than the manipulation amount m₂ (second manipulation amount), and r(i₁, m₁) (third value) may be smaller than r(i₁, m₂) (fourth value). In this case, the degree of the pseudo haptic sense increases as the manipulation amount m increases, and for example, the greater the manipulation amount m, the greater the degree of the pseudo haptic sense. Conversely, for example, the manipulation amount m₁ (first manipulation amount) may be greater than the manipulation amount m₂ (second manipulation amount), and r(i₁, m₁) (third value) may be greater than r(i₁, m₂) (fourth value). In this case, the degree of the pseudo haptic sense decreases as the manipulation amount m increases, and for example, the greater the manipulation amount m, the smaller the degree of the pseudo haptic sense. Alternatively, for example, in a case where the ratio r to the manipulation amount m₁ is r(i₁, m₁), the ratio r to the manipulation amount m₂ is r(i₁, m₂), and the ratio r to the manipulation amount m₃ is r(i₁, m₃) with respect to the manipulation amounts m₁, m₂, and m₃ satisfying m₁<m₂<m₃, r(i₁, m₂)<r(i₁, m₁) and r(i₁, m₂)<r(i₁, m₃) may be satisfied. In this case, the degree of the pseudo haptic sense presented at the manipulation amount m₂ is greater than the degrees of the pseudo haptic senses presented at the manipulation amounts m₁ and m₃ before and after the manipulation amount m₂. Conversely, r(i₁, m₂)>r(i₁, m₁) and r(i₁, m₂)>r(i₁, m₃) may be satisfied. In this case, the degree of the pseudo haptic sense presented at the manipulation amount m₂ is smaller than the degrees of the pseudo haptic senses presented at the manipulation amounts m₁ and m₃ before and after the manipulation amount m₂.

In addition, the index i representing the degree of the pseudo haptic sense may be switched according to the manipulation amount m. For example, in a case where the manipulation amount m changes from m₁ (first manipulation amount) to m₂ (second manipulation amount) and/or the manipulation amount m changes from m₂ (second manipulation amount) to m₁ (first manipulation amount) according to the manipulation (m₁ is different from m₂), the index i when the manipulation amount m is the manipulation amount m₁ (first manipulation amount) and the index i when the manipulation amount m is the manipulation amount m₂ (second manipulation amount) may be equal to or different from each other. In this manner, the degree of the pseudo haptic sense may be changed by switching the index i according to the manipulation amount m. In this case, the ratio r(i)=Δc/Δm corresponding to each index i may be constant regardless of the magnitude of m, or the ratio r(i)=Δc/Δm may be different according to the magnitude of m (for example, as described above). For example, even if the ratio r(i) corresponding to each index i is constant regardless of the magnitude of m, the degree of the pseudo haptic sense to be presented can be changed according to the manipulation amount m by switching the index i according to the manipulation amount m. For example, in a case where the manipulation amount m₁ is greater than the manipulation amount m₂ and the degree of the pseudo haptic sense represented by the index i₁ is greater than the degree of the pseudo haptic sense represented by the index i₂, the index may be switched to the index i₁ at the manipulation amount m₁, and may be switched to the index i₂ at the manipulation amount m₂. Conversely, the index may be switched to the index i₂ at the manipulation amount m₁, and may be switched to the index i₁ at the manipulation amount m₂. Alternatively, for example, in a case where the degree of the pseudo haptic sense represented by the index i₁ is greater than the degree of the pseudo haptic sense represented by the index i₂ and the degree of the pseudo haptic sense represented by the index i₂ is greater than the degree of the pseudo haptic sense represented by the index i₃ with respect to the manipulation amounts m₁, m₂, and m₃ satisfying m₁<m₂<m₃, the index may be switched to the index i₁ at the manipulation amount m₂, may be switched to the index i₂ at the manipulation amount m₁, and may be switched to the index i₃ at the manipulation amount m₃. Alternatively, in this case, the index may be switched to the index i₃ at the manipulation amount m₂, may be switched to the index i₂ at the manipulation amount m₁, and may be switched to the index i₃ at the manipulation amount m₃.

### First Embodiment

In a first embodiment, a case where the body part is a user's hand, the visual object is a disk-shaped two-dimensional figure, the motion of the body part is a gesture that moves the visual object up and down, the diameter of the visual object is changed by a magnitude of change according to a manipulation based on this motion, and the user is allowed to perceive a heaviness sense that is a pseudo haptic sense will be exemplified. However, this does not limit the present invention.

### <Configuration>

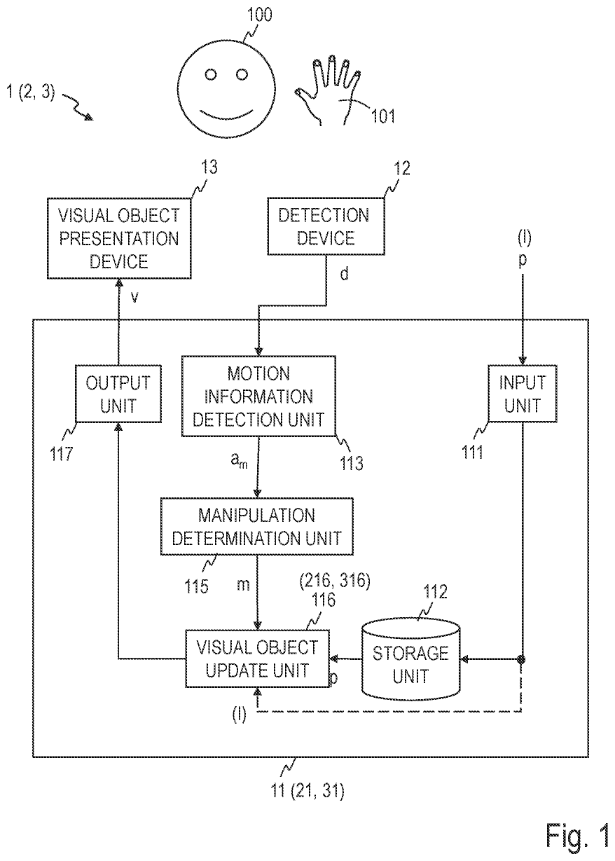

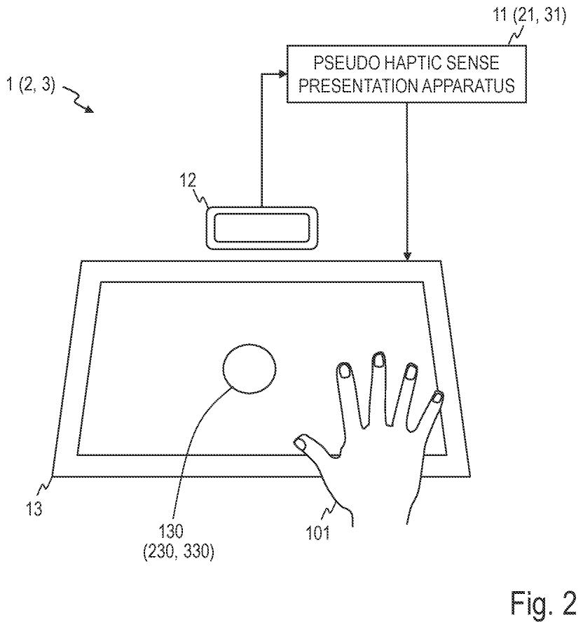

As illustrated in FIGS. 1 and 2, a pseudo haptic sense presentation system 1 according to the present embodiment includes a pseudo haptic sense presentation apparatus 11, a detection device 12, and a visual object presentation device 13.

The pseudo haptic sense presentation apparatus 11 includes an input unit 111, a storage unit 112, a motion information detection unit 113, a manipulation determination unit 115, a visual object update unit 116, and an output unit 117. Although the description is omitted hereafter, data obtained by each process is stored in the storage unit 112 and is read and used as necessary.

The detection device 12 is a device that detects a position of a body part 101 (for example, a hand) of a user 100 in the touchless environment, and outputs a detection result. An example of the detection device 12 is a hand tracker such as Leap motion (registered trademark), motion capture, a touchless display, an acceleration sensor, a gyro sensor, and the like, which do not limit the present invention.

The visual object presentation device 13 is a device that visually presents a visual object 130 to the user 100. Examples of the visual object presentation device 13 include a liquid crystal display, a virtual reality headset, a video projector, a stereoscopic hologram display, and the like, which do not limit the present invention.

### <Preprocessing>

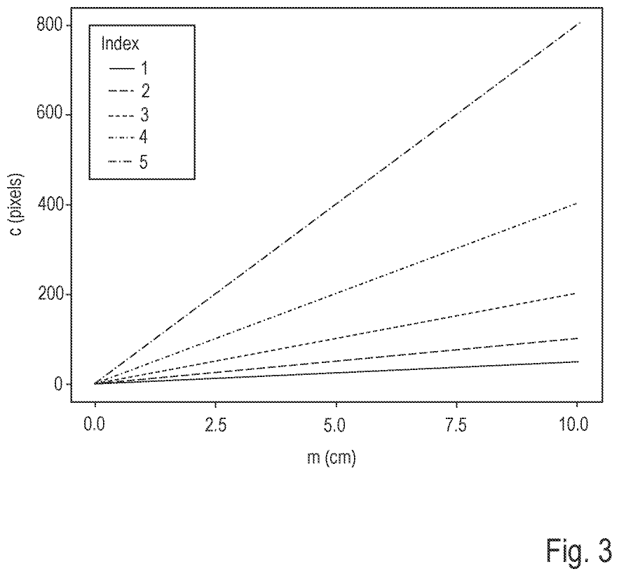

As preprocessing, at least information p indicating the relationship r between the magnitude of visual change c of the visual object 130 and the manipulation amount m based on the manipulation (manipulation based on the motion of the body part 101) is input to the input unit 111 and stored in the storage unit 112. Specific examples of the manipulation amount m, the visual object 130, the magnitude of change c, and the relationship r are as described above. For the sake of simplicity of description, in the present embodiment, a case where the visual object 130 is a disk-shaped two-dimensional figure, the magnitude of visual change c of the visual object 130 is a magnitude (positive value) of diameter change of the visual object 130, the manipulation amount m is a movement amount of a vertical component of the body part 101 (hand) based on the motion of the body part 101 to move the visual object 130 up and down, and the relationship r is a relationship between the magnitude of diameter change c of the visual object 130 and the manipulation amount m will be exemplified. However, this does not limit the present invention. FIG. 3 illustrates the relationship r between the magnitude of change c and the manipulation amount m. The horizontal axis in FIG. 3 exemplifies the manipulation amount m [cm] based on the motion of the body part 101. In the example of the present embodiment, the movement amount of the vertical component of the body part 101 (hand) is the manipulation amount m [cm]. The vertical axis in FIG. 3 exemplifies the magnitude of visual change c [pixels] of the visual object 130. In the example of the present embodiment, the magnitude of diameter change of the visual object 130, which is a disk-shaped two-dimensional figure, is the magnitude of visual change c [pixels]. As described above, only a single relationship r with respect to a degree of a single pseudo haptic sense may be defined, or a plurality of relationships r with respect to degrees of a plurality of pseudo haptic senses may be defined. In the example of FIG. 3, a plurality of relationships r with respect to degrees of a plurality of pseudo haptic senses are defined. That is, mutually different relationships r are defined according to indices (Index 1, . . . , and Index 5) representing degrees of mutually different pseudo haptic senses. The relationship r illustrated in FIG. 3 represents a ratio Δc/Δm of the change Δc in the magnitude of visual change c of the visual object 130 to the change Δm in the manipulation amount m. In the example of FIG. 3, the ratio Δc/Δm (slope) is constant regardless of the magnitude of m. That is, the relationship r between the manipulation amount m and the magnitude of change c illustrated in FIG. 3 is a linear relationship. The information p may include a function representing the relationship r, may include a table representing the relationship r, or may include a parameter representing the relationship r. Furthermore, the information p may include information (for example, information on the diameter of the initial visual object 130, information on the luminance, the color, and the pattern of the initial visual object 130, and the like) indicating the initial (initial state) visual object 130. However, if the initial state (for example, the diameter, the luminance, the color, the pattern, and the like of the initial visual object 130) of the visual object 130 is fixed (for example, the initial value of the diameter is 0), the information p may not include the information (for example, information on the diameter of the initial visual object 130, information on the luminance, the color, and the pattern of the initial visual object 130, and the like) of the initial visual object 130. Furthermore, the information p may include information b indicating in which direction the diameter of the visual object 130 is to be changed (increasing or decreasing the diameter) with respect to the positive magnitude of change c. For example, b=b₊ in a case where the diameter is increased with respect to the positive magnitude of change c, and b=b₋ in a case where the diameter is decreased with respect to the positive magnitude of change c. Here, b₊ is a positive real number and b₋ is a negative real number. The absolute value of b₊ and the absolute value of b₋ are desirably equal to each other, but they may be different from each other. An example of b₊ is +1, and an example of b₊ is −1. Alternatively, b₊ may be a positive function value of m (for example, a monotonically increasing function value or a monotonically decreasing function value), or b₋ may be a negative function value of m (for example, a monotonically increasing function value or a monotonically decreasing function value). However, these do not limit the present invention. Note that the information p may not include the information b as long as the direction in which the diameter of the visual object 130 is to be changed is fixed with respect to the positive magnitude of change c.

### <Operation>

Next, an operation of the pseudo haptic sense presentation system 1 according to the present embodiment will be exemplified.

The visual object update unit 116 (FIG. 1) generates the initial visual object 130 and outputs information v indicating the initial visual object 130. The initial visual object 130 exemplified in the present embodiment is a disk-shaped two-dimensional figure having a diameter of an initial value c₁. The initial value c₁ of the diameter may be a value included in the information p read from the storage unit 112, or may be a predetermined value. The luminance, the color, and the pattern of the initial visual object 130 may be values included in the information p read from the storage unit 112, or may be predetermined values. The information v indicating the initial visual object 130 is transmitted to the output unit 117, and is output from the output unit 117 to the visual object presentation device 13. The visual object presentation device 13 presents (displays) the visual object 130 on the basis of the transmitted information v (FIG. 2).

The user 100 moves the body part 101 (for example, a hand) in a touchless environment while viewing the visual object 130 presented by the visual object presentation device 13. The position of the body part 101 is detected by the detection device 12. Information d indicating the position of the body part 101 detected by the detection device 12 is output to the motion information detection unit 113. The position detection of the body part 101 and the output of the information d in the detection device 12 may be continuously performed at predetermined time intervals, for example, or may be performed each time the movement of the body part 101 is detected. Every time the information d is input, the motion information detection unit 113 detects the motion of the body part 101 from the information d and outputs information aₘ indicating the motion of the body part 101. The motion detection of the body part 101 and the output of the information aₘ are also continuously performed. The information aₘ indicating the motion is, for example, information indicating at least one of the position, the movement, and the movement amount m of the body part 101. In the present embodiment, an example is illustrated in which the information aₘ indicating the motion is information for specifying the movement amount m of the body part 101. A specific example of the movement amount m of the body part 101 is as described above. In the present embodiment, an example in which the vertical component of the distance from the motion start position of the body part 101 to the current position is used as the movement amount will be described. A specific example of the motion start position of the body part 101 is as described above. In the example of the present embodiment, the position of the body part 101 at the time of transition from a state in which the start condition, which is a combination of the above-described Condition 2 and Condition 3, is not satisfied to a state in which the start condition is satisfied is set as the motion start position. That is, in the example of the present embodiment, the position of the body part 101 at the time of transition to a state in which the body part 101 performs a specific trigger motion (Condition 2) and the positional relationship between the body part 101 and the presented visual object 130 or another position satisfies a predetermined condition (Condition 3) is set as the motion start position. The trigger motion may be any motion, but in the present embodiment, an example in which a pinching motion with a finger is used as the trigger motion will be described. Furthermore, the predetermined condition (Condition 3) that the positional relationship satisfies may be any condition. In the example of the present embodiment, the predetermined condition is that the body part 101 (for example, a hand) is away from the presentation position (for example, the display screen of the visual object presentation device 13) of the visual object 130 by more than a certain distance. In this case, the motion information detection unit 113 measures a distance d₁ between the thumb and the index finger, which are the body part 101 of the user 100, on the basis of the information d, further measures a distance d₂ between the body part 101 (for example, a hand) and the presentation position of the visual object 130 (for example, the display screen of the visual object presentation device 13), and outputs the distance d₁ and the distance d₂ as information aₘ=(d₁, d₂) indicating the motion of the body part 101.

The information aₘ=(d₁, d₂) is input to the manipulation determination unit 115. The manipulation determination unit 115 obtains and outputs manipulation information indicating a manipulation based on the motion of the body part 101 on the basis of the information aₘ. An example of the manipulation information is as described above, but in the present embodiment, an example in which information indicating the manipulation amount m is output as the manipulation information will be described. For example, first, the manipulation determination unit 115 determines whether or not the distance d₁ is less than a predetermined threshold value dₜₕ₁ (alternatively, whether or not the distance d₁ is equal to or less than the threshold value dₜₕ₁). Here, the threshold value dₜₕ₁ is a positive real number representing the distance. Here, in a case where the distance d₁ exceeds the threshold value dₜₕ₁ (alternatively, in a case where the distance d₁ is equal to or greater than the threshold value dₜₕ₁), the manipulation determination unit 115 determines that the pinching motion, that is, the trigger motion, on the body part 101 (the hand in this example) is not performed. On the other hand, in a case where the distance d₁ is equal to or less than the threshold value dₜₕ₁ (alternatively, in a case where the distance d₁ is less than the threshold value dₜₕ₁), the manipulation determination unit 115 determines that the trigger motion is performed (that is, it is determined that Condition 2 is satisfied). In addition, the manipulation determination unit 115 determines whether or not the distance d₂ exceeds a predetermined threshold value dₜₕ₂ (alternatively, whether or not the distance d₂ is equal to or greater than the threshold value dₜₕ₂). Here, the threshold value dₜₕ₂ is a positive real number representing the distance. Here, in a case where the distance d₂ is equal to or less than the threshold value dₜₕ₂ (alternatively, in a case where the distance d₂ is less than the threshold value dₜₕ₂), it is determined that the positional relationship of the body part 101 does not satisfy the predetermined condition. On the other hand, in a case where the distance d₂ exceeds the threshold value dₜₕ₂ (alternatively, in a case where the distance d₂ is equal to or greater than the threshold value dₜₕ₂), it is determined that the positional relationship of the body part 101 satisfies the predetermined condition (that is, it is determined that Condition 3 is satisfied). In a case where the trigger motion is performed and it is determined that the positional relationship of the body part 101 satisfies the predetermined condition (that is, in a case where it is determined that both Condition 2 and Condition 3 are satisfied), the manipulation determination unit 115 obtains a vertical component of the distance from the motion start position to the current position of the body part 101 as the movement amount on the basis of the distance d₂, and sets the movement amount as the manipulation amount m. Note that the motion start position is as described above. The motion start position exemplified in the present embodiment is the position of the body part 101 at the time of transition from a state in which at least one of Condition 2 or Condition 3 is not satisfied to a state in which both Condition 2 and Condition 3 are satisfied. The manipulation determination unit 115 outputs information indicating the manipulation amount m (manipulation information indicating a manipulation based on the motion of the body part) to the visual object update unit 116.

Information indicating the manipulation amount m is input to the visual object update unit 116. The visual object update unit 116 refers to the information p stored in the storage unit 112, and visually changes the visual object 130 by the magnitude of change according to the manipulation on the basis of at least the information indicating the manipulation amount m (manipulation information indicating the manipulation based on the motion of the body part) and the information p (information indicating the relationship between the magnitude of visual change of the visual object and the manipulation amount based on the manipulation). For example, if the information p represents only a single relationship r with respect to a degree of a single pseudo haptic sense, the visual object update unit 116 refers to this relationship r, obtains the magnitude of change c corresponding to the input manipulation amount m, and visually changes the visual object 130 from the initial state by the magnitude of change c. In the example of the present embodiment, the diameter of the visual object 130 is changed from the initial value c₁ to c₁+b·c. That is, the visual object update unit 116 in this example generates a disk-shaped visual object 130 having a diameter c₂=c₁+b·c, and outputs the information v indicating the visual object 130. b={b₊, b₋} may be information included in the information p or may be determined in advance. On the other hand, for example, if the information p represents a plurality of relationships r with respect to degrees of a plurality of pseudo haptic senses, the visual object update unit 116 refers to the relationship r corresponding to the degree of the pseudo haptic sense to be presented, obtains the magnitude of change c corresponding to the input manipulation amount m, and visually changes the visual object 130 from the initial state by the magnitude of change c. In the case of the example of FIG. 3, the visual object update unit 116 refers to the relationship r corresponding to an index (in the example of FIG. 3, any one of Index 1, . . . , and Index 5 is used) representing the degree of the pseudo haptic sense to be presented. As described above, the degree of the pseudo haptic sense to be presented may be determined in advance, may be determined on the basis of input information I input to the input unit 111, or may be determined on the basis of other processing. Also in this case, the visual object update unit 116 generates a disk-shaped visual object 130 having a diameter c₂=c₁+b·c, and outputs the information v indicating the visual object 130.

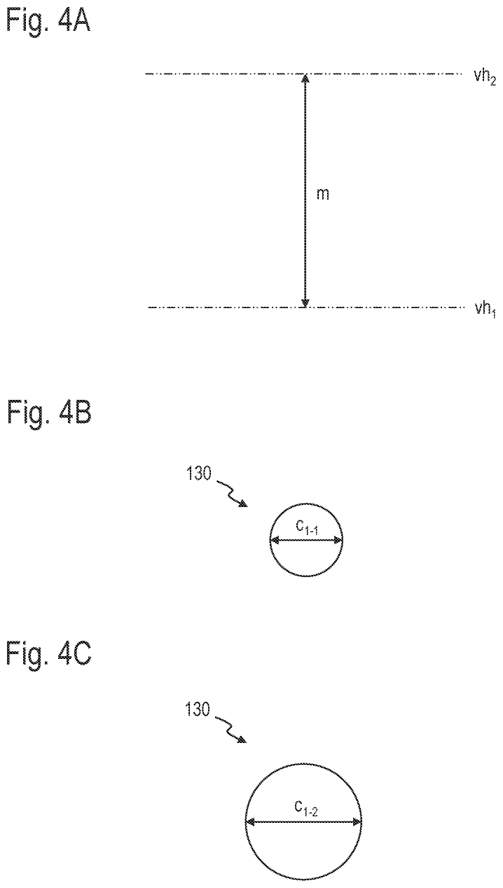

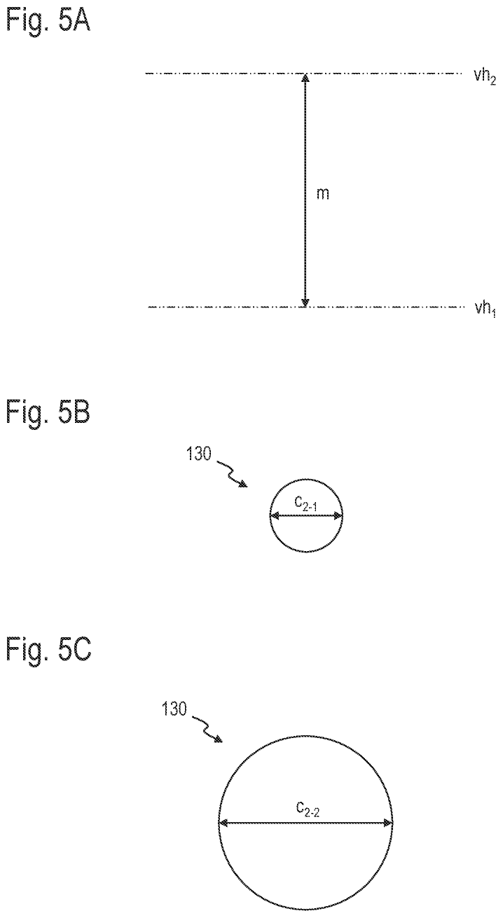

With reference to FIGS. 4A to 5C, a difference in change of the visual object 130 in a case where the degree of the pseudo haptic sense to be presented is different will be exemplified. For example, in a case where the index representing the degree of the pseudo haptic sense (for example, a heaviness sense, a weight sense, and a resistance sense) to be presented is Index 1 (FIG. 3), the visual object update unit 116 changes the diameter of the visual object 130 from the initial c₁=c₁₋₁ to c₂=c₁₋₂=c₁₋₁+b·c with respect to the manipulation amount m that is the vertical component of the distance from a motion start position vh₁ of the body part 101 to a current position vh₁. For example, if b=b₊, the visual object update unit 116 enlarges the diameter of the visual object 130 from c₁=c₁₋₁ to c₂=c₁₋₂ (FIGS. 4A to 4C), and if b=b₋, the visual object update unit 116 reduces the diameter of the visual object 130 from c₁=c₁₋₁ to c₂=c₁₋₂. On the other hand, in a case where the index representing the degree of the pseudo haptic sense to be presented is Index 2, the visual object update unit 116 changes the diameter of the visual object 130 from the initial c₁=c₂₋₁ to c₂=c₂₋₂=c₂₋₁+b·c with respect to the same manipulation amount m. For example, if b=b₊, the visual object update unit 116 enlarges the diameter of the visual object 130 from c₁=c₂₋₁ to c₂=c₂₋₂ (FIGS. 5A to 5C), and if b=b₋, the visual object update unit 116 reduces the diameter of the visual object 130 from c₁=c₂₋₁ to c₂=c₂₋₂. Here, the degree of the pseudo haptic sense (for example, a heaviness sense, a weight sense, and a resistance sense) represented by the index Index 1 is greater than the degree of the pseudo haptic sense represented by the index Index 2. In this case, although the manipulation amount m is the same, a magnitude of diameter change |c₁₋₂−c₁₋₁| of the visual object 130 with respect to the index Index 1 is smaller than a magnitude of diameter change |c₂₋₂−c₂₋₁| of the visual object 130 with respect to the index Index 2. Note that, in the example of the present embodiment, the position of the body part 101 at the time of transition from the state in which at least one of Condition 2 or Condition 3 is not satisfied to the state in which both Condition 2 and Condition 3 are satisfied is set as the motion start position. Therefore, the diameter of the visual object 130 is updated only when the trigger motion (pinching motion) is detected and it is detected that the body part 101 (for example, a hand) is away from the presentation position of the visual object 130 by a certain distance or more.

The information v indicating the visual object 130 output from the visual object update unit 116 is transmitted to the output unit 117, and is output from the output unit 117 to the visual object presentation device 13. The visual object presentation device 13 presents (displays) the visual object 130 on the basis of the transmitted information v (FIG. 2). Accordingly, the visual object 130 presented to the user 100 changes by the magnitude of change c according to the manipulation based on the motion of the body part 101, and a pseudo haptic sense (for example, a heaviness sense, a weight sense, and a resistance sense) can be presented to the user 100. Furthermore, if a plurality of relationships r with respect to degrees of a plurality of pseudo haptic senses are set, a pseudo haptic sense (for example, a heaviness sense, a weight sense, and a resistance sense of a selected magnitude) of a selected degree can be presented.

### <Experimental Results>

Next, experimental results of Experiment 1 for showing the effects of the first embodiment will be exemplified.

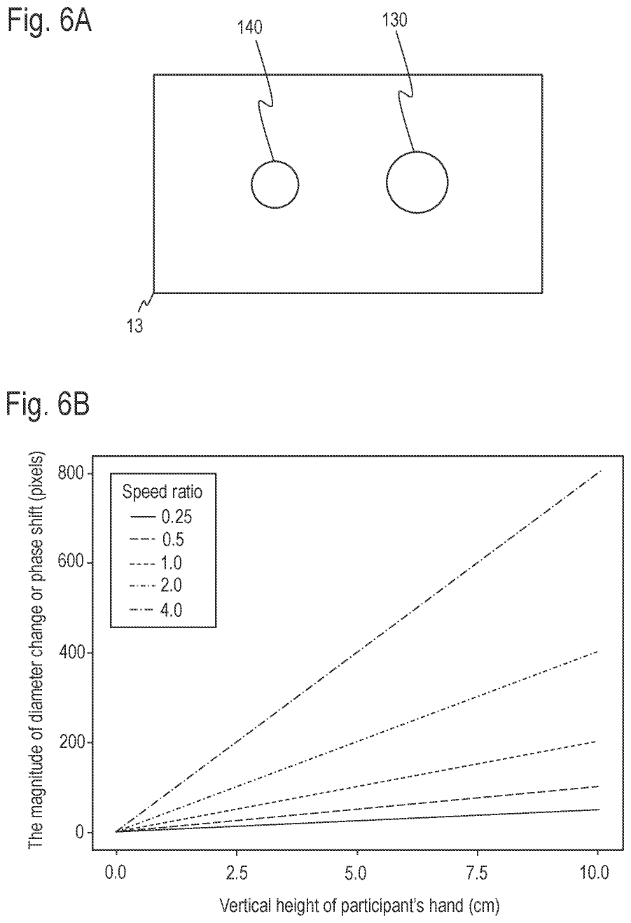

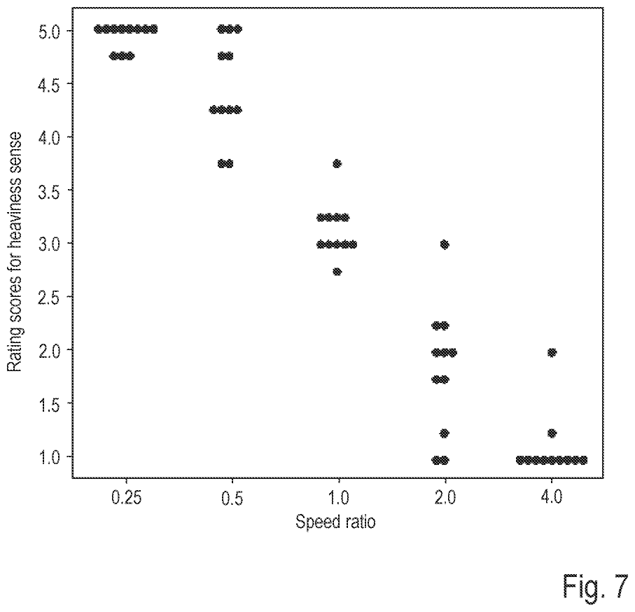

As illustrated in FIG. 6A, in Experiment 1, the visual object presentation device 13 presented the visual object 130 (evaluation stimulus) to be evaluated, and also presented a visual object 140 (standard stimulus) as a reference. Note that both the visual object 130 and the visual object 140 are disk-shaped two-dimensional images, and their diameters change by a magnitude of change based on the movement of the hand (body part) of the experiment participant. Here, the visual object 130 and the visual object 140 have different magnitudes of diameter change with respect to the manipulation amount. That is, the diameter of the visual object 140 changes by 20 [pixels] every time a height (vertical component of the movement amount) of the hand changes by 1 [cm]. On the other hand, for the visual object 130, every time the height of the hand changes by 1 [cm], Case 1 in which the diameter changes by 5 [pixels], Case 2 in which the diameter changes by 10 [pixels], Case 3 in which the diameter changes by 20 [pixels], Case 4 in which the diameter changes by 40 [pixels], and Case 5 in which the diameter changes by 80 [pixels] were tested. That is, the ratios (speed ratios) of the change of the visual object 130 to the change in diameter of the visual object 140 in Cases 1, 2, 3, 4, and 5 are 0.25, 0.5, 1.0, 2.0, and 4.0, respectively. FIG. 6B illustrates a magnitude of diameter change [pixels] of the visual object 130 with respect to the height [cm] of the hand of the experiment participant at each speed ratio. In Experiment 1, the horizontal axis in FIG. 6B represents the height [cm] of the hand of the experiment participant, and the vertical axis represents the magnitude of diameter change [pixels] of the visual object 130. The experiment participant compared the visual object 130 and the visual object 140 for Cases 1, 2, 3, 4, and 5, and reported which of these was felt heavier by a rating method. Specifically, the experiment participant reported in a 5-point scale with 5 types of rating scores of 1: the left disk (visual object 140) is considerably heavier, 2: the left disk (visual object 140) is slightly heavier, 3: the heaviness is the same on the left and right, 4: the right disk (visual object 130) is slightly heavier, and 5: the right disk (visual object 130) is considerably heavier. FIG. 7 shows the results of this experiment. In FIG. 7, the horizontal axis represents the speed ratio, and the vertical axis represents the average value of the rating scores (1 to 5) of the heaviness sense for each experiment participant. As illustrated in FIG. 7, it has been found that the visual object 130 feels heavier as the speed ratio is smaller. That is, the smaller the magnitude of diameter change of the visual object with respect to the manipulation amount based on the manipulation, the greater the perceived heaviness sense.

### Second Embodiment

In the first embodiment, the case where the visual object 130 is a disk-shaped two-dimensional figure, the motion of the body part 101 is a gesture that moves the visual object 130 up and down, the diameter of the visual object 130 is changed by a magnitude of change according to a manipulation based on this motion, and the user is allowed to perceive a heaviness sense that is a pseudo haptic sense has been exemplified. That is, in the first embodiment, an example has been shown in which the heaviness sense is perceived by changing the size of the visual object 130 by the magnitude of change according to the manipulation based on the motion. In a second embodiment, it is shown that the heaviness sense can be perceived by changing at least one of the luminance, the color, or the pattern of the visual object by the magnitude of change according to the manipulation based on the motion without changing the size or the shape of the visual object. In order to show this, in the present embodiment, it is assumed that a two-dimensional figure having concentric fringes with a fixed diameter is a visual object. In the second embodiment, the heaviness sense is perceived by changing a phase in the spatial region of the concentric fringes of the visual object (hereinafter simply referred to as a “phase”) by the magnitude of change according to the manipulation based on the motion.

Differences from the first embodiment will be mainly described below, and the same reference numerals will be used for the matters that have already been described to simplify the description.

### <Configuration>

As illustrated in FIGS. 1 and 2, a pseudo haptic sense presentation system 2 according to the present embodiment includes a pseudo haptic sense presentation apparatus 21, the detection device 12, and the visual object presentation device 13. The pseudo haptic sense presentation apparatus 21 includes the input unit 111, the storage unit 112, the motion information detection unit 113, the manipulation determination unit 115, a visual object update unit 216, and the output unit 117.

### <Preprocessing>

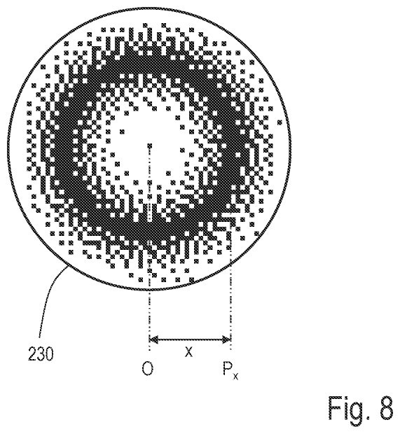

Preprocessing of the present embodiment is the same as the preprocessing of the first embodiment except that the visual object 130 is replaced with a visual object 230 that is a disk-shaped two-dimensional figure having concentric fringes with a fixed diameter (for example, FIG. 8), and the magnitude of diameter change c of the visual object 130 is replaced with a magnitude of phase change c of concentric fringes of the visual object 230. In the example of FIG. 3, one cycle in the spatial region of the concentric fringes of the visual object 230 is set to 100 [pixels]. That is, the magnitude of phase change c [pixels] of the concentric fringes of the visual object 230 represents a phase change of 2τ(c/100) [rad]. Note that FIG. 8 illustrates a case where the change in luminance value with respect to the change in distance from a center O of the concentric fringes in the spatial region is represented by a sine wave (that is, concentric fringes for sinusoidal luminance modulation). However, this does not limit the present invention as long as the change in luminance value with respect to the change in distance from the center O is concentric fringes having a periodic fringe structure. For example, the change in luminance value with respect to the change in distance from the center O may be represented by a rectangular wave, a triangular wave, or the like. In addition, similarly to the first embodiment, the information p may or may not include information of the initial visual object 230. Examples of the information of the initial visual object 230 include phase information (initial value of the phase) of concentric fringes of the initial visual object 230, and information on the size, the shape, the luminance, the color, and the pattern of the initial visual object 230. Furthermore, the information p may include information b={b₊, b₋} indicating in which direction the phase is changed with respect to the positive magnitude of change c.

### <Operation>

Next, an operation of the pseudo haptic sense presentation system 2 according to the present embodiment will be exemplified.

The visual object update unit 216 (FIG. 1) generates the initial visual object 230 and outputs information v indicating the initial visual object 230. The initial visual object 230 exemplified in the present embodiment has concentric fringes of the phase in the initial state. The phases of concentric fringes may be expressed in any way. For convenience of description, in the present embodiment, as illustrated in FIG. 8, the phase is expressed by a distance x in the spatial region from the center O of the concentric fringes to a position Pₓ where the luminance is a specific value (for example, 0 corresponding to black). However, this does not limit the present invention. According to this expression, the initial visual object 230 of the present embodiment is a disk-shaped two-dimensional figure having concentric fringes of a phase with the distance x being the initial value x₁. The initial value x₁ (initial value of the phase) of the distance x may be a value included in the information p read from the storage unit 112 or may be a predetermined value. The size, the shape, the luminance, the color, and the pattern of the initial visual object 230 may be values included in the information p read from the storage unit 112, or may be predetermined values. The information v indicating the initial visual object 230 is transmitted to the output unit 117, and is output from the output unit 117 to the visual object presentation device 13. The visual object presentation device 13 presents (displays) the visual object 230 on the basis of the transmitted information v (FIGS. 2 and 8).

The user 100 moves the body part 101 (for example, a hand) in a touchless environment while viewing the visual object 230 presented by the visual object presentation device 13. The position of the body part 101 is detected by the detection device 12. Information d indicating the position of the body part 101 detected by the detection device 12 is output to the motion information detection unit 113. Every time the information d is input, the motion information detection unit 113 detects the motion of the body part 101 from the information d and outputs information aₘ=(d₁, d₂) indicating the motion of the body part 101. The operations of the detection device 12 and the motion information detection unit 113 are the same as those in the first embodiment.

The information aₘ=(d₁, d₂) is input to the manipulation determination unit 115, and the manipulation determination unit 115 obtains and outputs manipulation information indicating a manipulation based on the motion of the body part 101 on the basis of the information aₘ. As in the first embodiment, also in the present embodiment, an example in which information indicating the manipulation amount m is output as manipulation information will be described. The operation of the manipulation determination unit 115 is the same as that of the first embodiment.

Information indicating the manipulation amount m is input to the visual object update unit 216. The visual object update unit 216 refers to the information p stored in the storage unit 112, and visually changes the visual object 230 by the magnitude of change according to the manipulation on the basis of at least the information indicating the manipulation amount m (manipulation information indicating the manipulation based on the motion of the body part) and the information p (information indicating the relationship between the magnitude of visual change of the visual object and the manipulation amount based on the manipulation). This operation is the same as the operation of the visual object update unit 116 of the first embodiment except that the phase of the concentric fringes of the visual object 230 is changed such that the distance x is from x₁ to x₂=x₁+b·c instead of changing the diameter of the visual object 130 from the initial value c₁ to c₂=c₁+b·c. In a case where the magnitude of change c is positive and b=b+, changing the phase of the concentric fringes of the visual object 230 such that the distance x is x₁ to x₂=x₁+b·c is moving the fringes of the concentric fringes in the direction from the center O toward the outside. That is, in a case where b=b₊, the higher the vertical position of the body part 101 (for example, a hand), the more the fringes are moved outward, and the lower the vertical position of the body part 101 (for example, a hand), the more the fringes are moved inward. In a case where the magnitude of change c is positive and b=b₋, changing the phase of the concentric fringes of the visual object 230 such that the distance x is x₁ to x₂=x₁+b·c is moving the fringes of the concentric fringes in the direction from the outside toward the center O. That is, in a case where b=b₋, the higher the height (vertical component of the movement amount) of the body part 101 (for example, a hand), the more the fringes are moved inward, and the lower the height of the body part 101 (for example, a hand), the more the fringes are moved outward. Note that the diameter (size) and the shape of the visual object 230 are not changed.

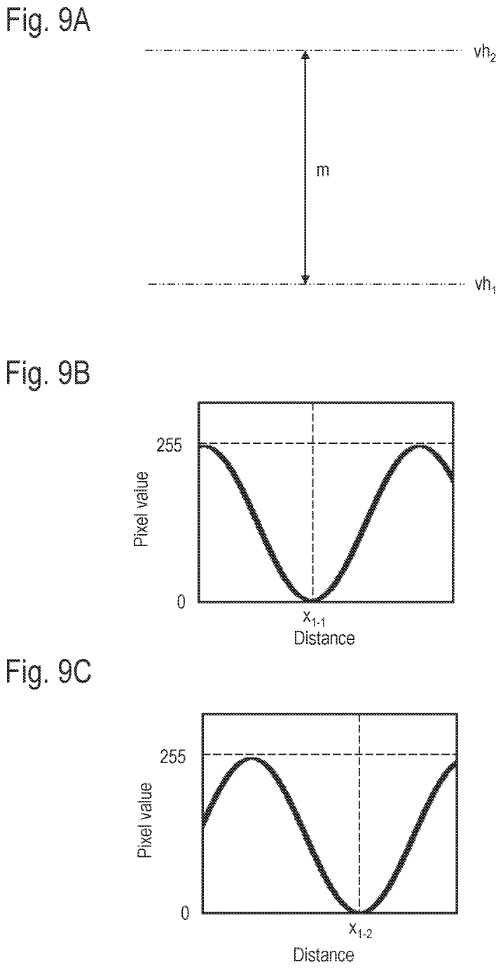

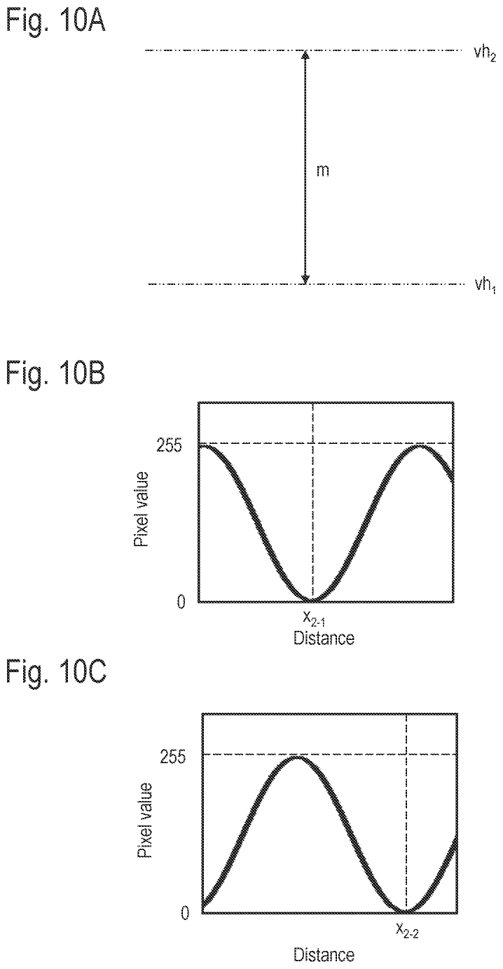

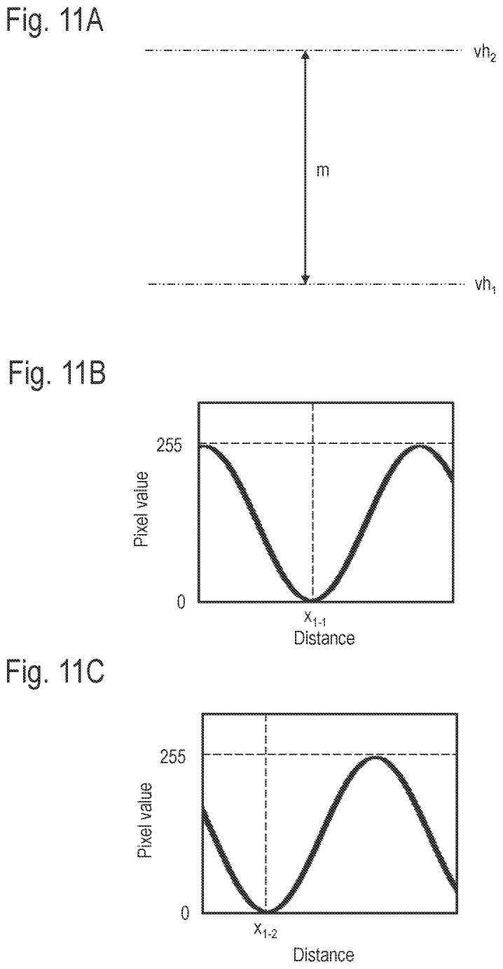

With reference to FIGS. 9A to 11C, a difference in change of the visual object 230 in a case where the degree of the pseudo haptic sense to be presented is different will be exemplified. In FIGS. 9B, 9C, 10B, 10C, 11B, and 11C, the horizontal axis represents the above-described distance x, and the vertical axis represents the pixel value. For example, in a case where the index representing the degree of the pseudo haptic sense (for example, a heaviness sense, a weight sense, and a resistance sense) to be presented is Index 1 (FIG. 3), the visual object update unit 216 changes the phase of the concentric fringes of the visual object 230 with respect to the manipulation amount m that is the vertical component of the distance from the motion start position vh₁ of the body part 101 to the current position vh₁ such that the distance x is from the initial x₁=x₁₋₁ to x₂=x₁₋₂=x₁₋₁+b·c. For example, if b=b+, the visual object update unit 216 moves the concentric fringes of the visual object 230 outward (FIGS. 9A to 9C), and if b=b₋, the visual object update unit 216 moves the fringes of the concentric fringes of the visual object 230 inward (FIGS. 11A to 11C). On the other hand, in a case where the index representing the degree of the pseudo haptic sense to be presented is Index 2, the visual object update unit 216 changes the phase of the concentric fringes of the visual object 230 with respect to the same manipulation amount m such that the distance x is from the initial x₁=x₂₋₁ to x₂=x₂₋₂=x₂₋₁+b·c. For example, if b=b+, the visual object update unit 216 moves the concentric fringes of the visual object 230 outward (FIGS. 10A to 10C), and if b=b₋, the visual object update unit 216 moves the fringes of the concentric fringes of the visual object 230 inward (FIGS. 11A to 11C). Here, the degree of the pseudo haptic sense (for example, a heaviness sense, a weight sense, and a resistance sense) represented by the index Index 1 is greater than the degree of the pseudo haptic sense represented by the index Index 2. In this case, although the manipulation amount m is the same, a magnitude of phase change |x₁₋₂−x₁₋₁| of the visual object 230 with respect to the index Index 1 is smaller than a magnitude of phase change |x₂₋₂−x₂₋₁| of the visual object 230 with respect to the index Index 2.

The information v indicating the visual object 130 output from the visual object update unit 216 is transmitted to the output unit 117, and is output from the output unit 117 to the visual object presentation device 13. The visual object presentation device 13 presents (displays) the visual object 230 on the basis of the transmitted information v (FIGS. 2 and 8). Accordingly, the visual object 230 presented to the user 100 changes by the magnitude of change c according to the manipulation based on the motion of the body part 101, and a pseudo haptic sense (for example, a heaviness sense, a weight sense, and a resistance sense) can be presented to the user 100. Furthermore, if the information p represents a plurality of relationships r with respect to degrees of a plurality of pseudo haptic senses, a pseudo haptic sense (for example, a heaviness sense, a weight sense, and a resistance sense of a selected magnitude) of a selected degree can be presented.

### <Experimental Results>

Next, experimental results of Experiments 2 and 3 for showing the effects of the second embodiment will be exemplified.

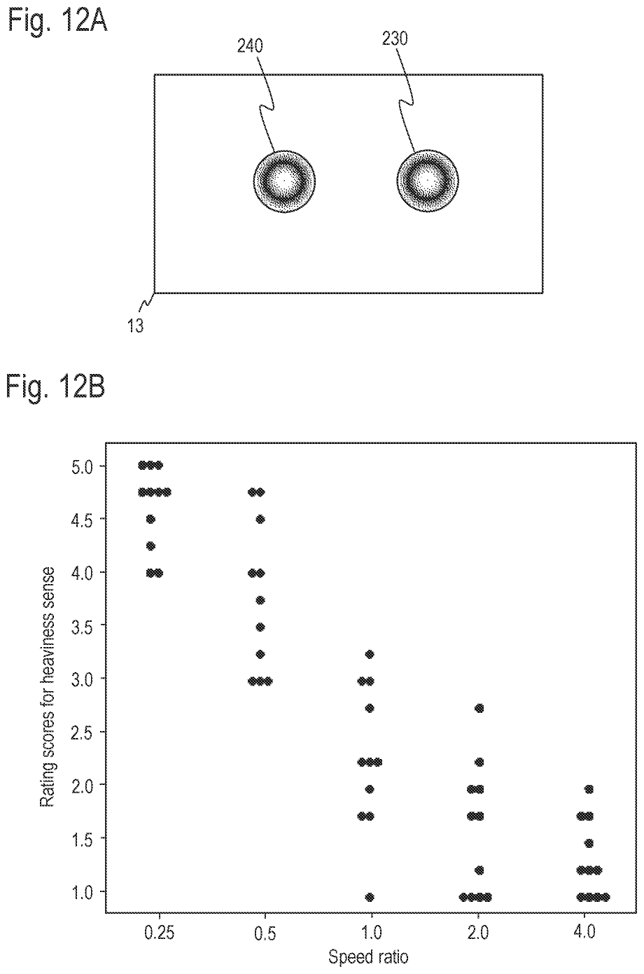

Experiment 2 is an experiment in a case where b=b₊, that is, the higher the vertical position of the body part 101 (for example, a hand), the more the fringes are moved outward, and the lower the vertical position of the body part 101 (for example, a hand), the more the fringes are moved inward. As illustrated in FIG. 12A, also in Experiment 2, the visual object presentation device 13 presented the visual object 230 (evaluation stimulus) to be evaluated, and also presented a visual object 240 (standard stimulus) as a reference. Note that both the visual object 230 and the visual object 240 are disk-shaped two-dimensional images having concentric fringes, and their phases change by a magnitude of change based on the movement of the hand of the experiment participant. Here, the visual object 230 and the visual object 240 have different magnitudes of phase change with respect to the manipulation amount. That is, in the visual object 240, the position of the fringe of the concentric fringes changes by 20 pixels every time the height (vertical component of the movement amount) of the hand changes by 1 [cm]. That is, in a case where one cycle in the spatial region of the concentric fringes is 100 [pixels], the phase of the concentric fringes changes by 0.4 n [rad] every time the height of the hand changes by 1 [cm]. On the other hand, for the visual object 230, every time the height of the hand changes by 1 [cm], Case 1 in which the position of the fringe of the concentric fringes changes by 5 [pixels], Case 2 in which the position of the fringe of the concentric fringes changes by 10 [pixels], Case 3 in which the position of the fringe of the concentric fringes changes by 20 [pixels], Case 4 in which the position of the fringe of the concentric fringes changes by 40 [pixels], and Case 5 in which the position of the fringe of the concentric fringes changes by 80 [pixels] were tested. That is, in a case where one cycle in the spatial region of the concentric fringes is 100 [pixels], the phase changes by 0.1 n, 0.2 n, 0.4 n, 0.8 n, and 1.6 n [rad] every time the height of the hand changes by 1 [cm] in Cases 1, 2, 3, 4, and 5. That is, the ratios (speed ratios) of the phase of the visual object 230 to the change in phase of the visual object 240 in Cases 1, 2, 3, 4, and 5 are 0.25, 0.5, 1.0, 2.0, and 4.0, respectively. FIG. 6B illustrates a magnitude of phase change [pixels] of the concentric fringes of the visual object 130 with respect to the height [cm] of the hand of the experiment participant at each speed ratio. In Experiment 2, the horizontal axis in FIG. 6B represents the height [cm] of the hand of the experiment participant, and the vertical axis represents the magnitude of phase change [pixels] of the concentric fringes of the visual object 230. The experiment participant compared the visual object 230 and the visual object 240 for Cases 1, 2, 3, 4, and 5, and reported which of these was felt heavier by a rating method. The evaluation was performed in the same manner as in Experiment 1 by a 5-point scale with rating scores of 1 to 5. FIG. 12B shows the experimental results of Experiment 2. In FIG. 12B, the horizontal axis represents the speed ratio, and the vertical axis represents the average value of the rating scores (1 to 5) of the heaviness sense for each experiment participant. As illustrated in FIG. 12B, it has been found that the visual object 230 feels heavier as the speed ratio is smaller. That is, in the case of b=b₊, the smaller the magnitude of phase change of the concentric fringes of the visual object 230 with respect to the manipulation amount based on the manipulation, the greater the perceived heaviness sense. From this result, it can be seen that even if there is no change in the size and the shape of the visual object, the heaviness sense can be perceived by changing the phase of the concentric fringes of the visual object 230 according to the manipulation amount based on the manipulation.

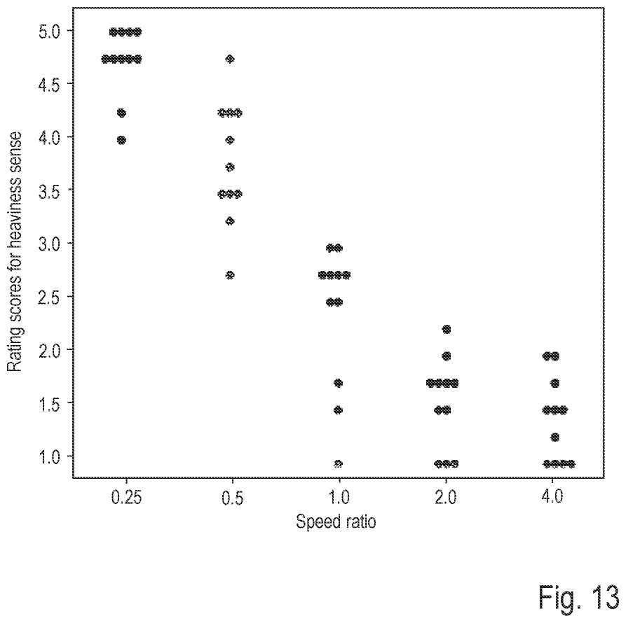

Experiment 3 is an experiment in a case where b=b₋, that is, the higher the vertical position of the body part 101 (for example, a hand), the more the fringes are moved inward, and the lower the vertical position of the body part 101 (for example, a hand), the more the fringes are moved outward. The experimental method is the same as in Experiment 2 except that b=b₋. FIG. 13 shows the experimental results of Experiment 3. In FIG. 13, the horizontal axis represents the speed ratio, and the vertical axis represents the average value of the rating scores (1 to 5) of the heaviness sense for each experiment participant. As illustrated in FIG. 13, it has been found that the visual object 230 feels heavier as the speed ratio is smaller. That is, also in the case of b=b₋, the smaller the magnitude of phase change of the concentric fringes of the visual object 230 with respect to the manipulation amount based on the manipulation, the greater the perceived heaviness sense. From this result, it can be seen that the heaviness sense can be perceived by changing the phase of the concentric fringes of the visual object 230 according to the manipulation amount based on the manipulation regardless of the changing direction of the phase of the concentric fringes (moving direction of the fringes).

### Third Embodiment

In the second embodiment, the heaviness sense is perceived by changing the phase of the concentric fringes of the visual object by the magnitude of change according to the manipulation based on the motion. However, this effect can be obtained not only in the case where the phases of the concentric fringes are changed but also in the case where the phases of other figures are changed. In order to show this, in the present embodiment, it is assumed that a two-dimensional figure having one-dimensional fringes is a visual object. The size and the shape of the visual object of the present embodiment do not change. Differences from the first and second embodiments will be mainly described below, and the same reference numerals will be used for the matters that have already been described to simplify the description.

As illustrated in FIGS. 1 and 2, a pseudo haptic sense presentation system 3 according to the present embodiment includes a pseudo haptic sense presentation apparatus 31, the detection device 12, and the visual object presentation device 13. The pseudo haptic sense presentation apparatus 31 includes the input unit 111, the storage unit 112, the motion information detection unit 113, the manipulation determination unit 115, a visual object update unit 316, and the output unit 117.

### <Preprocessing>

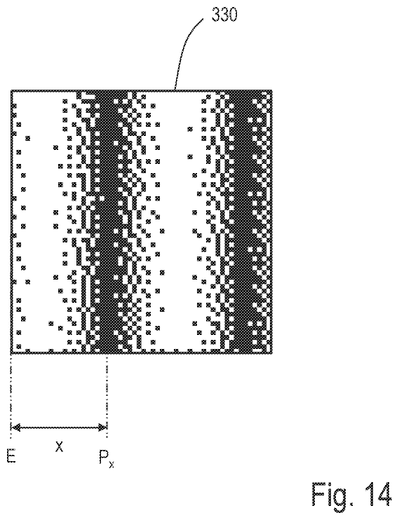

Preprocessing of the present embodiment is the same as the preprocessing of the first embodiment except that the visual object 130 is replaced with a visual object 330 that is a rectangular two-dimensional figure having one-dimensional fringes with a fixed size (for example, FIG. 14), and the magnitude of diameter change c of the visual object 130 is replaced with a magnitude of phase change c of one-dimensional fringes of the visual object 330. Note that FIG. 14 illustrates a case where the change in luminance value with respect to the change in distance from an edge E of the visual object 330 in the spatial region is represented by a sine wave (that is, one-dimensional fringes for sinusoidal luminance modulation). However, this does not limit the present invention as long as the change in luminance value with respect to the change in distance from the edge E is one-dimensional fringes having a periodic fringe structure. For example, the change in luminance value with respect to the change in distance from the edge E may be represented by a rectangular wave, a triangular wave, or the like. Similarly to the first embodiment, the information p may or may not include information of the initial visual object 330. Examples of the information of the initial visual object 330 include phase information (initial value of the phase) of one-dimensional fringes of the initial visual object 330, and information on the size, the shape, the luminance, the color, and the pattern of the initial visual object 330. Furthermore, the information p may include information b={b₊, b₋} indicating in which direction the phase is changed with respect to the positive magnitude of change c.

### <Operation>

Next, an operation of the pseudo haptic sense presentation system 3 according to the present embodiment will be exemplified.

The visual object update unit 316 (FIG. 1) generates the initial visual object 330 and outputs information v indicating the initial visual object 330. The initial visual object 330 exemplified in the present embodiment has one-dimensional fringes of the phase in the initial state. The phases of one-dimensional fringes may be expressed in any way. For convenience of description, in the present embodiment, as illustrated in FIG. 14, the phase is expressed by a distance x in the spatial region from the edge E of one-dimensional fringes to a position Pₓ where the luminance is a specific value (for example, 0 corresponding to black). However, this does not limit the present invention. According to this expression, the initial visual object 330 of the present embodiment is a rectangular two-dimensional figure having one-dimensional fringes of a phase with the distance x being the initial value x₁. The initial value x₁ (initial value of the phase) of the distance x may be a value included in the information p read from the storage unit 112 or may be a predetermined value. The size, the shape, the luminance, the color, and the pattern of the initial visual object 330 may be values included in the information p read from the storage unit 112, or may be predetermined values. The information v indicating the initial visual object 330 is transmitted to the output unit 117, and is output from the output unit 117 to the visual object presentation device 13. The visual object presentation device 13 presents (displays) the visual object 330 on the basis of the transmitted information v (FIGS. 2 and 14).

The user 100 moves the body part 101 (for example, a hand) in a touchless environment while viewing the visual object 330 presented by the visual object presentation device 13. The position of the body part 101 is detected by the detection device 12. Information d indicating the position of the body part 101 detected by the detection device 12 is output to the motion information detection unit 113. Every time the information d is input, the motion information detection unit 113 detects the motion of the body part 101 from the information d and outputs information aₘ=(d₁, d₂) indicating the motion of the body part 101. The operations of the detection device 12 and the motion information detection unit 113 are the same as those in the first embodiment.

The information aₘ=(d₁, d₂) is input to the manipulation determination unit 115, and the manipulation determination unit 115 obtains and outputs manipulation information indicating a manipulation based on the motion of the body part 101 on the basis of the information aₘ. As in the first embodiment, also in the present embodiment, an example in which information indicating the manipulation amount m is output as manipulation information will be described. The operation of the manipulation determination unit 115 is the same as that of the first embodiment.

Information indicating the manipulation amount m is input to the visual object update unit 316. The visual object update unit 316 refers to the information p stored in the storage unit 112, and visually changes the visual object 330 by the magnitude of change according to the manipulation on the basis of at least the information indicating the manipulation amount m (manipulation information indicating the manipulation based on the motion of the body part) and the information p (information indicating the relationship between the magnitude of visual change of the visual object and the manipulation amount based on the manipulation). This operation is the same as the operation of the visual object update unit 116 of the first embodiment except that the phase of the one-dimensional fringes of the visual object 330 is changed such that the distance x is from x₁ to x₂=x₁+b·c instead of changing the diameter of the visual object 130 from the initial value c₁ to c₂=c₁+b·c. In a case where the magnitude of change c is positive and b=b₊, changing the phase of the one-dimensional fringes of the visual object 330 such that the distance x is x₁ to x₂=x₁+b·c is moving the fringes of the one-dimensional fringes rightward from the edge E. That is, in a case where b=b₊, the higher the vertical position of the body part 101 (for example, a hand), the more the fringes are moved to the right, and the lower the vertical position of the body part 101 (for example, a hand), the more the fringes are moved to the left. In a case where the magnitude of change c is positive and b=b₋, changing the phase of the one-dimensional fringes of the visual object 330 such that the distance x is x₁ to x₂=x₁+b·c is moving the fringes of the one-dimensional fringes in the direction from the right to the edge E (leftward). That is, in a case where b=b₋, the higher the height (vertical component of the movement amount) of the body part 101 (for example, a hand), the more the fringes are moved to the left, and the lower the height of the body part 101 (for example, a hand), the more the fringes are moved to the right. Note that the size and the shape of the visual object 330 are not changed.

The information v indicating the visual object 130 output from the visual object update unit 316 is transmitted to the output unit 117, and is output from the output unit 117 to the visual object presentation device 13. The visual object presentation device 13 presents (displays) the visual object 330 on the basis of the transmitted information v (FIGS. 2 and 14). Accordingly, the visual object 330 presented to the user 100 changes by the magnitude of change c according to the manipulation based on the motion of the body part 101, and a pseudo haptic sense (for example, a heaviness sense, a weight sense, and a resistance sense) can be presented to the user 100. Furthermore, if the information p represents a plurality of relationships r with respect to degrees of a plurality of pseudo haptic senses, a pseudo haptic sense (for example, a heaviness sense, a weight sense, and a resistance sense of a selected magnitude) of a selected degree can be presented.

### <Experimental Results>

Next, experimental results of Experiment 4 for showing the effects of the third embodiment will be exemplified.

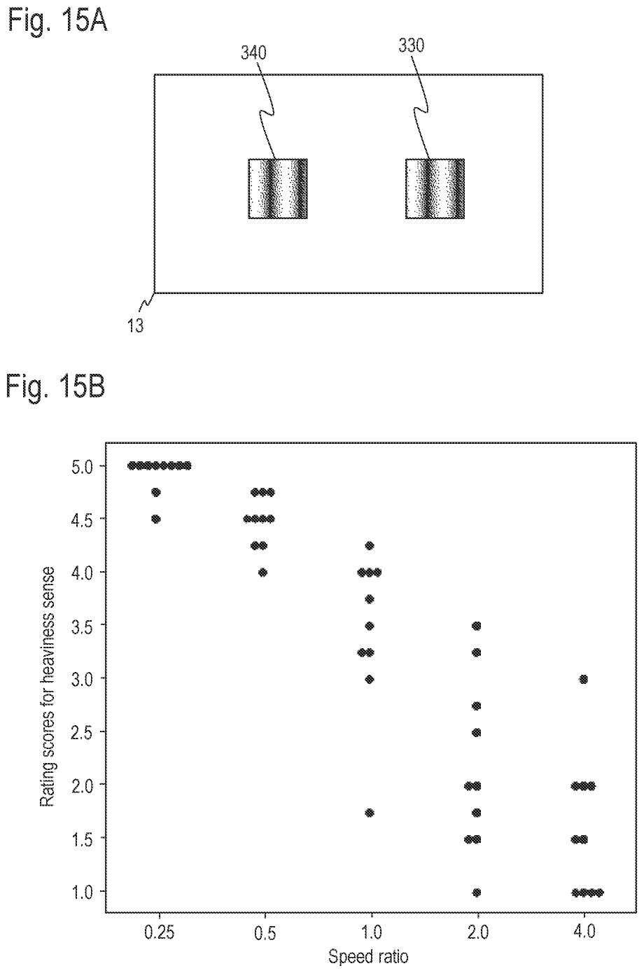

As illustrated in FIG. 15A, also in Experiment 4, the visual object presentation device 13 presented the visual object 330 (evaluation stimulus) to be evaluated, and also presented a visual object 340 (standard stimulus) as a reference. Note that both the visual object 330 and the visual object 340 are rectangular two-dimensional images having one-dimensional fringes, and their phases change by a magnitude of change based on the movement of the hand of the experiment participant. Here, the visual object 330 and the visual object 340 have different magnitudes of phase change with respect to the manipulation amount. That is, in the visual object 340, the position of the one-dimensional fringe changes by 20 pixels every time the height (vertical component of the movement amount) of the hand changes by 1 [cm]. That is, in a case where one cycle in the spatial region of the one-dimensional fringes is 100 [pixels], the phase of the one-dimensional fringes changes by 0.4 n [rad] every time the height of the hand changes by 1 [cm]. On the other hand, for the visual object 330, every time the height of the hand changes by 1 [cm], Case 1 in which the position of the fringe of the one-dimensional fringes changes by 5 [pixels], Case 2 in which the position of the fringe of the concentric fringes changes by 10 [pixels], Case 3 in which the position of the fringe of the concentric fringes changes by 20 [pixels], Case 4 in which the position of the fringe of the concentric fringes changes by 40 [pixels], and Case 5 in which the position of the fringe of the concentric fringes changes by 80 [pixels] were tested. That is, even in the case of Experiment 4, the ratios (speed ratios) of the phase of the visual object 330 to the change in phase of the visual object 340 in Cases 1, 2, 3, 4, and 5 are 0.25, 0.5, 1.0, 2.0, and 4.0, respectively (FIG. 6B). As in Experiments 2 and 3, in Experiment 4, the horizontal axis in FIG. 6B represents the height [cm] of the hand of the experiment participant, and the vertical axis represents the magnitude of phase change [pixels] of the one-dimensional fringes of the visual object 330. The experiment participant compared the visual object 330 and the visual object 340 for Cases 1, 2, 3, 4, and 5, and reported which of these was felt heavier by a rating method. The evaluation was performed in the same manner as in Experiment 1 by a 5-point scale with rating scores of 1 to 5. FIG. 15B shows the experimental results of Experiment 4. In FIG. 15B, the horizontal axis represents the speed ratio, and the vertical axis represents the average value of the rating scores (1 to 5) of the heaviness sense for each experiment participant. As illustrated in FIG. 15 B, in this case as well, it has been found that the visual object 330 feels heavier as the speed ratio is smaller. That is, the smaller the magnitude of phase change of the one-dimensional fringes of the visual object 330 with respect to the manipulation amount based on the manipulation, the greater the perceived heaviness sense. Furthermore, from this result, it can be seen that the heaviness sense can be perceived by changing the phase of the fringes of the visual object 330 according to the manipulation amount based on the manipulation regardless of the type of fringes and the spatial structure.

### OTHER MODIFICATION EXAMPLES

In the first to third embodiments, an example has been described in which the size and the phase of the visual object are changed by the magnitude of change according to the manipulation on the basis of the manipulation information indicating the manipulation based on the motion of the body part and the information indicating the relationship between the magnitude of visual change of the visual object and the manipulation amount based on the manipulation, thereby allowing the user to perceive the heaviness sense. However, the present invention is not limited thereto as described above. For example, the shape of the visual object may be a disk shape, an elliptical shape, a rectangular shape, another polygonal shape, or any other shape. There is no limitation on the visual change of the visual object. For example, the manner of changing the size of the visual object is not limited to that of the first embodiment, and the size of the visual object may be changed while the visual object is deformed by the magnitude of change according to the manipulation, or the size or the shape of the visual object may be changed while at least one of the luminance, the color, or the pattern of the visual object is changed. The phase of the periodic fringes of the visual object may be changed while the size and the shape of the visual object are changed by the magnitude of change according to the manipulation. The visual object is a two-dimensional image (for example, a white noise image or the like) having an aperiodic pattern, and at least one of the size, the shape, the pattern, the luminance, and the color of the visual object may be changed by the magnitude of change according to the manipulation. Furthermore, as described above, for the same index i, the relationship r (for example, r=Δc/Δm) may be constant, or the relationship r (for example, r=Δc/Δm) may be different according to the magnitude of m. As described above, the visual object update units 116, 216, and 316 may switch the index i representing the degree of the pseudo haptic sense according to the manipulation amount m, refer to the relationship r corresponding to the switched index i, obtain the magnitude of change c corresponding to the input manipulation amount m, and visually change the visual object 130 by the obtained magnitude of change.

Also, various kinds of processing described above may be executed not only in time series in accordance with the description but also in parallel or individually in accordance with processing capabilities of the devices that execute the processes or as necessary. It is needless to say that appropriate modifications can be made without departing from the scope of the present invention.

### [Hardware Configuration]

Each of the pseudo haptic sense presentation apparatus 11, 21, and 31 according to each embodiment is a device configured with a general-purpose or dedicated computer executing a predetermined program, the computer including a processor (a hardware processor) such as a central processing unit (CPU) and a memory such as a random access memory (RAM) and a read only memory (ROM), for example. That is, each of the pseudo haptic sense presentation apparatus 11, 21, and 31 according to each embodiment includes, for example, processing circuitry configured to implement each unit included in each of the pseudo haptic sense presentation apparatus. The computer may include one processor and one memory, or may include a plurality of processors and a plurality of memories. The program may be installed into the computer, or may be recorded in a ROM or the like in advance. Also, some or all of the processing units may be configured using an electronic circuit that independently implements the processing functions, rather than an electronic circuit (circuitry) that forms the functional components by reading the program like a CPU. Also, an electronic circuit forming one device may include a plurality of CPUs.

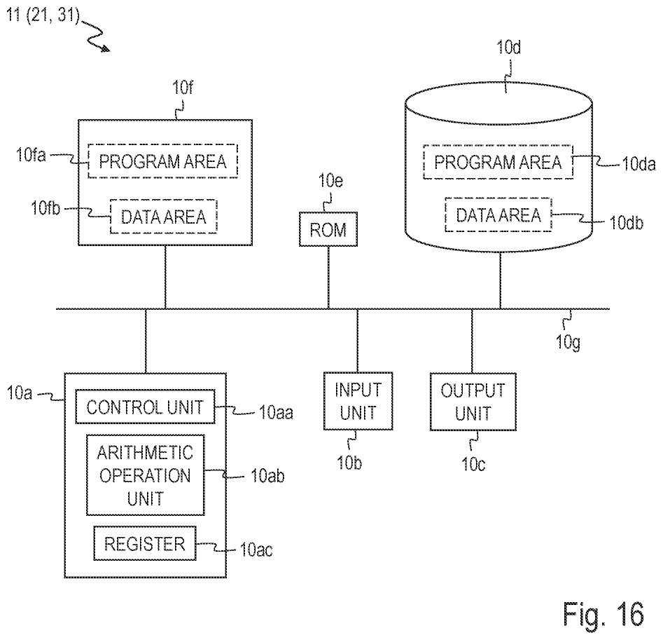

FIG. 16 is a block diagram illustrating a hardware configuration of each of the pseudo haptic sense presentation apparatus 11, 21, and 31 according to each embodiment. As illustrated as the example in FIG. 16, each of the pseudo haptic sense presentation apparatus 11, 21, and 31 of this example includes a central processing unit (CPU) 10a, an input unit 10b, an output unit 10c, a random access memory (RAM) 10d, a read only memory (ROM) 10e, an auxiliary storage device 10f, and a bus 10g. The CPU 10a in this example includes a control unit 10aa, an arithmetic operation unit 10ab, and a register 10ac, and executes various arithmetic operations in accordance with various programs read into the register 10ac. The input unit 10b is an input terminal, a keyboard, a mouse, a touch panel, or the like to which data is input. The output unit 10c is an output terminal from which data is output, a display, or a LAN card or the like controlled by the CPU 10a that has read a predetermined program. The RAM 10d is a static random-access memory (SRAM), a dynamic random-access memory (DRAM), or the like, and incudes a program area 10da in which a predetermined program is stored and a data area 10db in which various kinds of data are stored. The auxiliary storage device 10f is a hard disk, a magneto-optical disc (MO), a semiconductor memory, or the like, for example, and includes a program area 10fa in which a predetermined program is stored and a data area 10fb in which various kinds of data are stored. The bus 10g connects the CPU 10a, the input unit 10b, the output unit 10c, the RAM 10d, the ROM 10e, and the auxiliary storage device 10f so that information can be exchanged among these components. The CPU 10a writes, into the program area 10da of the RAM 10d, the program stored in the program area 10fa of the auxiliary storage device 10f in accordance with a read operating system (OS) program. Likewise, the CPU 10a writes, into the data area 10db of the RAM 10d, the various kinds of data stored in the data area 10fb of the auxiliary storage device 10f. Addresses on the RAM 10d at which the program and the data have been written are stored into the register 10ac of the CPU 10a. The control unit 10aa of the CPU 10a sequentially reads these addresses stored in the register 10ac, reads the program and the data from the areas in the RAM 10d indicated by the read addresses, causes the arithmetic operation unit 10ab to sequentially execute arithmetic operations indicated by the program, and stores results of the arithmetic operations into the register 10ac. With such a configuration, the functional components of the pseudo haptic sense presentation apparatus 11, 21, and 31 are obtained.

The program described above can be recorded in a computer-readable recording medium. Examples of the computer-readable recording medium include a non-transitory recording medium. Examples of such a recording medium include a magnetic recording device, an optical disc, a magneto-optical recording medium, a semiconductor memory, and the like.

The program is distributed by selling, giving, or renting portable recording media such as DVDs or CD-ROMs recording the program thereon, for example. Furthermore, a configuration in which the program is stored in a storage device in a server computer and is distributed by transfer from the server computer to other computers via a network may also be employed. As described above, the computer executing such a program first stores a program recorded in a portable recording medium or a program transferred from the server computer temporarily into a storage device of the computer, for example. At the time of execution of a process, the computer reads the program stored in the storage device of the computer, and performs processing in accordance with the read program. Also, in other modes of execution of the program, the computer may read the program directly from a portable recording medium and performs processing in accordance with the program, or alternatively, the computer may sequentially perform processing in accordance with a received program every time a program is transferred from the server computer to the computer. Moreover, the above-described processing may be executed by a so-called application service provider (ASP) type service that implements a processing function only by an execution instruction and result acquisition without transferring the program from the server computer to the computer. Note that the program in the present embodiment includes information that is used for processing by an electronic computer and is equivalent to the program (data or the like that is not a direct command to the computer but has property that defines processing performed by the computer).

Although this device is configured with a computer executing a predetermined program in each embodiment, at least some of the processing contents may be implemented by hardware.

### REFERENCE SIGNS LIST

11, 21, 31 Pseudo haptic sense presentation apparatus
116, 216, 316 Visual object update unit

1. A pseudo haptic sense presentation apparatus comprising:
a visual object update processing circuitry that visually changes a visual object by a magnitude of visual change of the visual object according to a manipulation based on a motion of a body part on the basis of manipulation information indicating the manipulation and information indicating a relationship between the magnitude of visual change and a manipulation amount based on the manipulation; and
an output processing circuitry that outputs information for presenting the visually changed visual object,
wherein the relationship is defined at least according to a degree of a pseudo haptic sense to be presented.

2. The pseudo haptic sense presentation apparatus according to claim 1, wherein
the magnitude of visual change of the visual object corresponds to a magnitude of change of at least one of a size, a shape, a luminance, a color, or a pattern of the visual object, and
the visual object update processing circuitry changes at least one of a size, a shape, a luminance, a color, or a pattern of the visual object.

3. The pseudo haptic sense presentation apparatus according to claim 1, wherein
the relationship is a ratio of a change in the magnitude of change to a change in the manipulation amount,
the ratio in a case where an index representing the degree of the pseudo haptic sense is a first index value is a first value, and
the ratio in a case where the index is a second index value different from the first index value is a second value different from the first value.

4. The pseudo haptic sense presentation apparatus according to claim 3, wherein
a degree of the pseudo haptic sense represented by the first index value is greater than a degree of the pseudo haptic sense represented by the second index value, and
the first value is smaller than the second value.

5. The pseudo haptic sense presentation apparatus according to claim 3, wherein
the manipulation amount changes from a first manipulation amount to a second manipulation amount and/or the manipulation amount changes from the second manipulation amount to the first manipulation amount according to the manipulation,
the first manipulation amount is different from the second manipulation amount,
the ratio when the manipulation amount is the first manipulation amount is a third value, and
the ratio when the manipulation amount is the second manipulation amount is a fourth value different from the third value.

6. The pseudo haptic sense presentation apparatus according to claim 5, wherein
the first manipulation amount is greater than the second manipulation amount, and
the third value is smaller than the fourth value, or the third value is greater than the fourth value.

7. A pseudo haptic sense presentation method comprising:
a visual object update step of visually changing a visual object by a magnitude of visual change of the visual object according to a manipulation based on a motion of a body part on the basis of manipulation information indicating the manipulation and information indicating a relationship between the magnitude of visual change and a manipulation amount based on the manipulation; and
an output step of outputting information for presenting the visually changed visual object,
wherein the relationship is defined at least according to a degree of a pseudo haptic sense to be presented.

8. A non-transitory computer-readable recording medium storing a program for causing a computer to function as the pseudo haptic sense presentation apparatus according to claim 1.
